(19) United States
(12) Patent Application Publication
(10) Pub. No.: US 2015/0134435 A1
(43) Pub. Date: May 14, 2015

(54) SALES REGISTRATION APPARATUS AND METHOD FOR ISSUING VOUCHER BY THE SAME

(71) Applicant: TOSHIBA TEC KABUSHIKI KAISHA, Tokyo (JP)

(72) Inventor: Takashi Shibuya, Osaka (JP)

(21) Appl. No.: 14/531,003

(22) Filed: Nov. 3, 2014

(30) Foreign Application Priority Data
Nov. 13, 2013 (JP) 2013-235450

(51) Int. Cl. G06Q 30/02; G07G 5/00

(52) U.S. Cl. CPC G06Q 30/0222; G07G 5/00
USPC 705/14.23

(57) ABSTRACT

A sales registration apparatus includes a storage device which previously stores a number of sheets setting data indicating whether the number of issue sheets of a voucher is set without regard to a purchase quantity of a commodity or to be equal to the purchase quantity of the commodity for each voucher of a plurality of categories, an issuing module configured to issue vouchers of the plurality of categories, a determination module configured to determine, in response to the sales registration of the commodity for which the voucher of at least one category is issued, the number of issue sheets of the voucher based on the number of sheets setting data and the purchase quantity of the commodity, and an issuing control module configured to control the issuing module to issue the voucher by the number of issue sheets determined by the determination module upon the purchase of the commodity.

### CROSS-REFERENCE TO RELATED APPLICATION

This application is based upon and claims the benefit of priority from Japanese Patent Application No. 2013-235450, filed Nov. 13, 2013, the entire contents of which are incorporated herein by reference.

### FIELD

Embodiments described herein relate generally to a sales registration apparatus and a method for issuing voucher by the sales registration apparatus.

### BACKGROUND

It is considered or desired to enable a POS (Point Of Sales) terminal and the like to issue vouchers of a plurality of categories such as a warranty certificate, an exchange ticket and the like, freely. Until now, it is premised to determine the number of issue sheets of each voucher with the same condition regardless of the category of the voucher.

However, for example, it is generally desired to issue the warranty certificate in association with each commodity. On the contrary, for example, inmost cases, only one exchange ticket is needed to be issued for the commodities in the same category or the same commodities, even though the purchase quantity is more than one.

According to the premise described above, in a case in which a plurality of categories of vouchers are issued freely, it is difficult to issue an appropriate number of vouchers for each category of vouchers.

Thus, it is desired that a plurality of categories of vouchers can be issued freely, and meanwhile, an appropriate number of vouchers can be issued according to the characteristic, e.g. use or purpose, of each category of vouchers.

### BRIEF DESCRIPTION OF THE DRAWINGS

FIG. 1 is a block diagram illustrating a POS terminal according to one embodiment;

FIG. 2 is a diagram illustrating data stored in an auxiliary storage unit shown in FIG. 1;

FIG. 3 is a diagram schematically illustrating the constitution of a data record of a single item master file shown in FIG. 2;

FIG. 4 is a diagram schematically illustrating the constitution of the number of sheets setting data shown in FIG. 2;

FIG. 5 is a flowchart illustrating a receipt issuing processing; and

FIG. 6 is a diagram illustrating examples of issue results of receipt tickets.

### DETAILED DESCRIPTION

In accordance with one embodiment, a sales registration apparatus includes a storage device which previously stores a number of sheets setting data indicating whether the number of issue sheets of a voucher is set without regard to a purchase quantity of a commodity or to be equal to the purchase quantity of the commodity for each voucher of a plurality of categories, an issuing module configured to issue vouchers of the plurality of categories, a determination module configured to determine, in response to the sales registration of the commodity for which the voucher of at least one category within the plurality of categories thereof is issued, the number of issue sheets of the voucher based on the number of sheets setting data stored in the storage device and the purchase quantity of the commodity, and an issuing control module configured to control the issuing module to issue the voucher by the number of issue sheets determined by the determination module upon the purchase of the commodity.

Hereinafter, one embodiment of the present invention is described with reference to the accompanying drawings. In the present embodiment, a POS terminal having functions of a sales registration apparatus is exemplified.

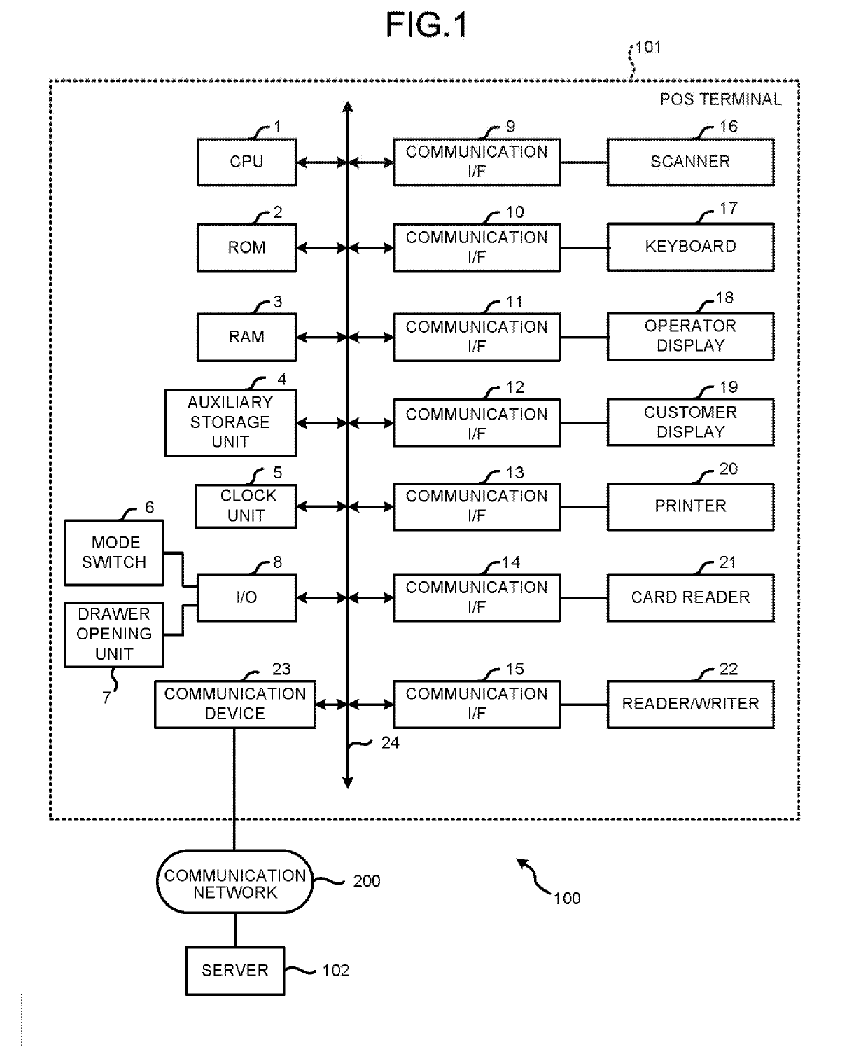

FIG. 1 is a block diagram illustrating a POS terminal 101.

The POS terminal 101 is one component of a POS system 100. The POS system 100 further includes a server 102. Generally, a plurality of POS terminals 101 are arranged in the POS system 100. As occasion demands, the POS system 100 may include a plurality of servers 102.

The POS terminal 101 carries out various kinds of data processing relating to commodity sales such as registering a purchased commodity, calculating a purchase amount, settlement processing or point giving/subtracting processing and the like.

The server 102 includes a so-called store server arranged in the store in which the POS terminal 101 is arranged and a so-called headquarters server arranged in a headquarters collectively running a plurality of stores in which the POS terminal 101 is arranged. The server 102 totalizes sales data generated respectively by the POS terminal 101 and other POS terminals (not shown) and manages data used by each POS terminal. The POS terminal 101 and the server 102 are connected with each other through a communication network 200. For example, either of at LAN (local area network) and an internet, or combination of the LAN and the internet may be used as the communication network 200. As to the server 102, an existing general computer can be used as a hardware. Functions of the server 102 can be realized by the computer which executes programs for realizing various functions mentioned above.

The POS terminal 101 includes a CPU (central processing unit) 1, a ROM (read-only memory) 2, a RAM (random-access memory) 3, an auxiliary storage unit 4, a clock unit 5, a mode switch 6, a drawer opening unit 7, an input/output port (I/O) 8, communication interfaces (communication I/F) 9-15, a scanner 16, a keyboard 17, a display for operator 18, a display for customer 19, a printer 20, a card reader 21, a reader/writer 22, a communication device 23 and a bus line 24. The bus line 24 including an address bus and a data bus and the like connects the CPU 1, the ROM 2, the RAM 3, the auxiliary storage unit 4, the clock unit 5, the input/output port 8, the communication interfaces 9-15 and the communication device 23 with each other.

The CPU 1 is a central part of a computer. The CPU 1 controls each section of the POS terminal to realize various operations of the POS terminal 101 according to an operating system, a middleware and an application program stored in the ROM 2 and the RAM 3.

The ROM 2 is a main storage part of the computer. The ROM 2 stores the operating system mentioned above. As occasion demands, the ROM 2 also stores the middleware and the application program mentioned above, and data referred to with the CPU 1 which carries out various processing.

The RAM 3 is also a main storage part of the computer. The RAM 3 stores data referred to with the CPU 1 which carries out various processing. The RAM 3 is further used as a so-called work area for temporarily storing data used by the CPU 1 which carries out various processing. Part of the storage area of the RAM 3 is used as a commodity list area.

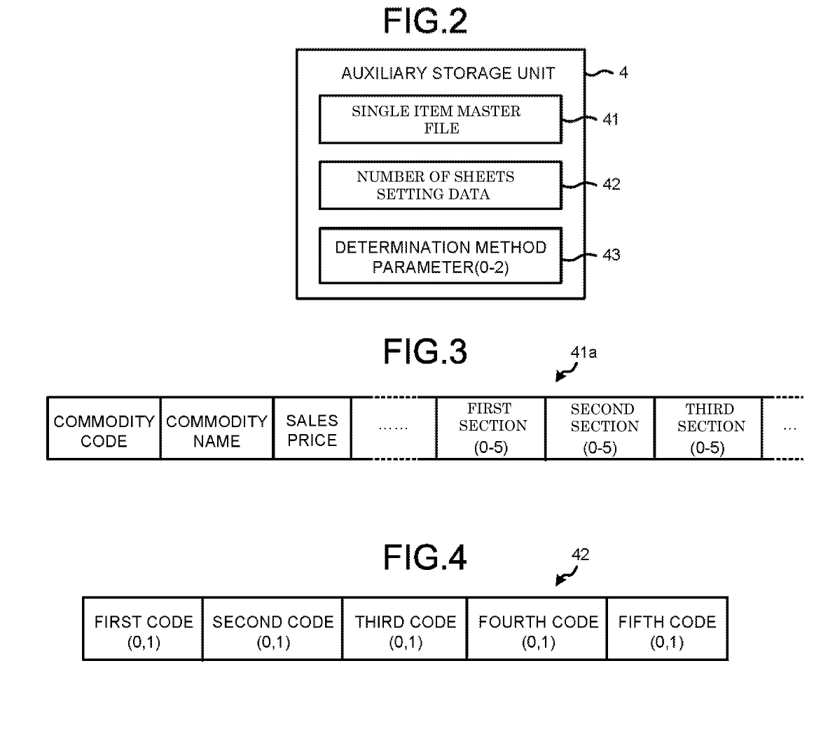

The auxiliary storage unit 4 is an auxiliary storage part of the computer. The auxiliary storage unit 4, which is, for example, an HDD (hard disk drive), or an SSD (solid state drive) and the like, stores data used by the CPU 1 which carries out various processing and data generated through the processing carried out by the CPU 1. As shown in FIG. 2, the auxiliary storage unit 4 stores a single item master file 41, a number of sheets setting data 42 and a determination method parameter 43.

The single item master file 41 is a data table in which information relating to a commodity subject to a purchase registration by the POS terminal 101 is recorded.

FIG. 3 is a diagram schematically illustrating the constitution of a data record 41a of the single item master file 41.

The data record 41a includes information such as a commodity code, a commodity name, a sales price and first-third sections.

The commodity code is used for identifying each commodity subject to the purchase registration by the POS terminal 101. The commodity name indicates the name of a commodity identified with the commodity code. The sales price indicates the sales price of the commodity. Each of the first-third sections refers to the category of vouchers issued upon the completion of one checkout closing processing. The voucher mentioned herein refers to, for example, a warranty certificate, an exchange ticket, an exchange ticket (copy for store), a coupon, a service ticket or a reservation ticket and the like different from a general transaction receipt (hereinafter referred to as a general receipt) indicating content of the sales or purchase transaction. In the present embodiment, the voucher is issued with a receipt paper as described later, and therefore, the voucher is referred to as a receipt ticket.

Numbers for respectively identifying the first-third issued receipt tickets are respectively recorded in the first-third sections. In the present embodiment, five categories of the receipt tickets can be issued, and therefore, the numbers thereof are set to No. 1-5. In addition, a value of “0” indicating that no receipt ticket is issued may also be recorded in the first-third sections. In this way, any one of 0 to 5 is recorded in the first-third sections.

The value of each of the first-third sections can be set freely according to, for example, the circumstances of the store in which the POS system 100 is used. The value of each of the first-third sections can be properly changed by the CPU 1 according to an instruction of an operator. Specifically, the CPU 1 receives a designation on whether or not a receipt ticket is issued along with the purchase of the commodity and a designation on the category of the receipt ticket if the receipt ticked is issued through a GUI (graphical user interface) displayed on the display for operator 18, and then writes a value corresponding to the designation in the first-third sections.

More specifically, if a receipt ticket is not issued along with the purchase of the commodity, the CPU 1 sets all the first-third sections to “0”. If it is designated to issue a receipt ticket, the CPU 1 receives a designation on the categories of the receipt tickets to be issued to first-third sections, and writes the designated category number in each section. However, in a case in which the third receipt ticket is not issued, the CPU 1 sets “0” in the third section, and in a case in which the second receipt ticket is not issued, the CPU 1 sets “0” in the second section.

FIG. 4 is a diagram schematically illustrating the constitution of the number of sheets setting data 42.

The number of sheets setting data 42 includes first-fifth codes. Each of the first-fifth codes is set to a value of “0” or “1”. The first-fifth codes refer to the setting on the number of issue sheets of each of receipt tickets No. 1-5. “0” indicates to set a specified number of sheets (which can be any value, and is set to 1 in the present embodiment) as the number of issue sheets regardless of the purchase quantity of a commodity. “1” indicates to set the number of sheets equal to the purchase quantity of a commodity as the number of issue sheets.

The value of each of the first-fifth codes can be determined freely according to, for example, the circumstances of the store in which the POS system 100 is used. In addition, the value of each of the first-fifth codes can be properly changed through the CPU 1 according to an instruction of the operator. Specifically, the CPU 1 receives a designation on whether the specified number of sheets (which can be any value, and is set to 1 in the present embodiment) as the number of issue sheets regardless of the purchase quantity or the number of issue sheets equal to the purchase quantity as the number of issue sheets for each of the receipt tickets No. 1-5 by the operator through the GUI displayed on the display for operator 18, and then writes a value corresponding to the designation in the number of sheets setting data 42.

In this way, the auxiliary storage unit 4 is used as a storage device for storing the number of sheets setting data.

The determination method parameter 43 refers to a method for determining the number of issue sheets of each of the receipt tickets. The determination method parameter 43 can be set to any one value from 0 to 2. “0” indicates to determine the specified number of sheets (which can be any value, and is set to 1 in the present embodiment) as the number of issue sheets regardless of the purchase quantity of a commodity. “1” indicates to determine the number of sheets equal to the purchase quantity as the number of issue sheets. “2” indicates to determine the number of issue sheets based on the number of sheets setting data 42 and the purchase quantity.

The determination method parameter 43 can be determined freely according to, for example, the circumstances of the store in which the POS system 100 is used. In addition, the value of the determination method parameter 43 can be properly changed through the CPU 1 according to an instruction of the operator. Specifically, the CPU 1 receives a designation on whether the specified number of sheets (which can be any value, and is set to 1 in the present embodiment) is determined as the number of issue sheets regardless of the purchase quantity of a commodity, the number of sheets equal to the purchase quantity is determined as the number of issue sheets, or the number of sheets is determined based on the number of sheets setting data 42 and the purchase quantity by the operator through the GUI displayed on the display for operator 18, and then sets a value corresponding to the designation as the determination method parameter 43. In this way, the CPU 1 functions as a change module.

The application program stored in the ROM 2 or the auxiliary storage unit 4 includes a control program relating to a later-described receipt issuing processing. The transfer of the POS terminal 101 is generally carried out in a state in which the control program is stored in the ROM 2 or the auxiliary storage unit 4. Alternatively, the POS terminal 101 is transferred in a state in which the control program is not stored in the ROM 2 or the auxiliary storage unit 4. In this case, the control program is transferred in a state in which it is recorded in a removable recording medium such as a magnetic disc, a magnetic optical disk, an optical disk, a semiconductor memory and the like, or transferred through a network, and then the control program is written in the ROM 2, the RAM 3 or the auxiliary storage unit 4 of the POS terminal 101 transferred separately as described above.

The clock unit 5 counts time steadily to generate date and time information indicating the current date and time. For example, a TOD (time of day) clock can be used as the clock unit 5.

The mode switch 6 detects the direction or position of a key hole (key) rotatable by a specific key and outputs the detection result as a mode signal. Different work modes are respectively allocated to the directions or positions of the key hole (key), and the mode signal indicates which one of the work modes is selected. The well-known work modes include a registration mode, an inspection mode, an adjustment mode and the like. In the registration mode, if a PLU (Price Look Up) code is input through the scanner 16 or the keyboard 17, the data processing relating to the sales or the supply of the commodity identified with the PLU code is carried out. In the inspection mode, total sales data obtained from the sales data generated through the processing carried out in the registration mode is output as a report. In the adjustment mode, the total sales data is cleared after being output as a report in the same way as the inspection mode.

The drawer opening unit 7 opens a drawer automatically.

The input/output port 8 converts the mode signal output from the mode switch 6 into mode data and writes the mode data in the RAM 3. Further the input/output port 8 outputs a drive signal for driving the drawer opening unit 7 to the drawer opening unit 7 in response to a drawer opening instruction from the CPU 1 of the POS terminal 101.

The communication interfaces 9-15 are connected with the scanner 16, the keyboard 17, the display for operator 18, the display for customer 19, the printer 20 and the card reader 21, respectively. The communication interfaces 9-15 interface the communication between each of these connected devices and the CPU 1. A device based on well-known standards such as an RS (recommended standard)-232C, a PS/2, a USB (universal serial bus), a VGA (video graphics array), a DVI (digital video interface), an LVDS (low voltage differential signaling), an IEEE (institute of electrical and electronic engineers) 1284 (so-called centronics specification) and the like can be properly used as the communication interface. Typically, the USB is used as the communication interface 9, the PS/2 or the USB is used as the communication interface 10, the USB, VGA, DVI or the LVDS is used as the communication interface 11, the RS-232C, USB, VGA, DVI or the LVDS is used as the communication interface 12, the IEEE 1284 or the USB is used as the communication interface 13, and the RS-232C or the USB is used as the communication interfaces 14 and 15.

The scanner 16 reads the barcode printed on the sheet attached to a commodity, slip or discount coupon to output the information indicated by the barcode. The scanner 16 may be a fixed-type scanner, a handy-type scanner or a scanner including both types.

The keyboard 17 outputs a command indicating the content of an operation by the operator.

The display for operator 18, which is, for example, an LCD (liquid crystal display), displays an image under the control of the CPU 1. The display for operator 18 is used to display an image indicating various kinds of information to be indicated to the operator.

The display for customer 19, which is, for example, an LCD or a fluorescent tube display, displays an image under the control of the CPU 1. The display for customer 19 is used to display an image indicating various kinds of information to be indicated to the customer.

The printer 20, which is, for example, a thermal printer or an impact dot printer, prints various character strings or images and the like on a receipt paper to issue a general receipt or receipt ticket.

The card reader 21 reads a personal credit data recorded in a credit card.

The reader/writer 22 reads point data recorded in a point card. The reader/writer 22 writes point data indicating points given to or taken from a cardholder into the point card.

The communication device 23 communicates with the server 102 through the communication network 200. For example, an existing LAN communication device can be used as the communication device 23.

Next, the operation of the POS terminal 101 having the constitution described above is described.

The general processing carried out in the POS system such as the registration processing, the adjustment processing or the settlement processing of the purchased commodity may be carried out in the same way as an existing POS system. After the closing processing relating to one checkout or one transaction is completed, the CPU 1 starts the receipt issuing processing according to the control program stored in the ROM 2 or the auxiliary storage unit 4. The content of the processing described below is just exemplified as one example, and the same result can be obtained through various processing properly.

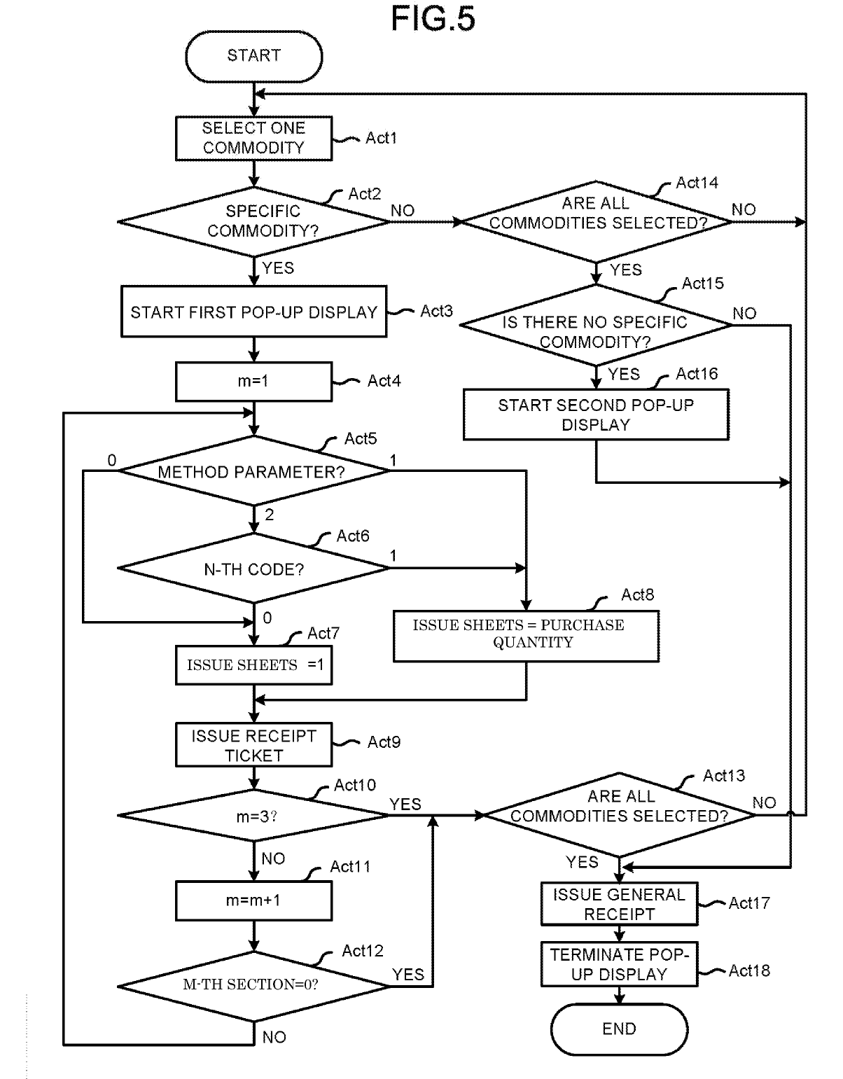

FIG. 5 is a flowchart illustrating the receipt issuing processing.

In ACT 1, the CPU 1 selects one commodity not yet selected in the current receipt issuing processing from the commodities purchased in the one transaction described above. The commodity selected herein is referred to as a selected commodity in the following description.

In ACT 2, the CPU 1 confirms whether or not the selected commodity is a specific commodity. The specific commodity refers to a commodity for which a receipt ticket needs to be issued upon the purchase of the commodity. Specifically, in a case in which the value in the first section included in the data record (hereinafter, referred to as a focused record) 41a relating to the selected commodity in the single item master file 41 is not “0”, the CPU 1 determines that the commodity is the specific commodity. In this case, YES is taken in ACT 2, and then ACT 3 is executed.

In ACT 3, the CPU 1 controls the display for operator 18 to start a first pop-up display. An image to be displayed on the first pop-up display is stored in, for example, the auxiliary storage unit 4 in advance. The first pop-up display notifies the operator that the receipt ticket and the general receipt are being issued.

In ACT 4, the CPU 1 sets a variable m to 1.

In ACT 5, the CPU 1 confirms the value of the determination method parameter 43. If the value of the determination method parameter 43 is 2, the CPU 1 executes the processing in ACT 6.

In a case in which the value recorded in the m-th section is represented by n, the CPU 1 confirms the value of the n-th code in ACT 6. If the value of the n-th code is 0, the CPU 1 executes the processing in ACT 7. On the other hand, if it is determined in ACT 5 that the value of the determination method parameter 43 is 0, the CPU 1 proceeds to ACT 7 from ACT 5 without executing the processing in ACT 6.

In ACT 7, the CPU 1 sets the number of issue sheets to 1.

If the value of the n-th code is 1 in ACT 6, the CPU 1 proceeds to ACT 8 from ACT 6. If it is determined in ACT 5 that the value of the determination method parameter 43 is 1, the CPU 1 proceeds to ACT 8 from ACT 5 without executing the processing in ACT 6.

In ACT 8, the CPU 1 sets the number of sheets equal to the purchase quantity of the selected commodity as the number of issue sheets.

In this way, if the value of the determination method parameter 43 is set to 2, the number of issue sheets is determined according to the setting value of the number of sheets setting data 42 relating to the category of the receipt ticket to be issued. On the contrary, if the value of the determination method parameter 43 is set to 0 or 1, the number of issue sheets is fixed regardless of the category of the receipt ticket to be issued. The CPU 1 functions as the determination module.

In ACT 9, the CPU 1 controls the printer 20 to issue the receipt ticket of No. n by the number of issue sheets set in ACT 7 or ACT 8. In this way, the printer 20 functions as the issuing module and the CPU 1 functions as the issuing control module.

In ACT 10, the CPU 1 confirms whether or not the variable m reaches to 3 (the number of sections included in the focused data record 41a of the single item master file 41). If it is determined that the variable m is 1 or 2, NO is taken in ACT 10 and thus the CPU 1 executes the processing in ACT 11.

In ACT 11, the CPU 1 increases the value of the variable m by 1.

In ACT 12, the CPU 1 confirms whether or not the value of the m-th section included in the focused record is 0. If it is determined that the value of the m-th section is not 0 in ACT 12, NO is taken and thus the CPU 1 repeats the processing following ACT 5.

In this way, in a case in which any value from 1 to 5 is recorded in the second section and the value is represented by n, the receipt ticket of No. n is issued. In this case, the number of issue sheets is determined again based on the value of the determination method parameter 43 and the value of the n-th code.

If it is determined that YES is taken in ACT 10 because the variable m reaches to 3, the CPU 1 proceeds to ACT 13 from ACT 10. That is, after the receipt ticket of each of the three categories is issued according to the first-third sections, the CPU 1 executes the processing in ACT 13.

On the other hand, if it is determined that YES is taken in ACT 12 because the value of the m-th section is 0, the CPU 1 executes the processing in ACT 13. In a case in which it is determined that receipt ticket of only one category is issued because the value of the second section is set to 0 and then the issue of receipt ticket of the one category is completed, and in a case in which it is determined that the receipt tickets of only two categories of are issued because the value of the third section is set to 0 and then the issue of the receipt tickets of the two categories is completed, the CPU 1 proceeds to ACT 13 from ACT 12. In other words, after the issue of the receipt tickets to be issued relating to the selected commodity is completed, the CPU 1 executes the processing in ACT 13.

In ACT 13, the CPU 1 confirms whether or not all the purchased commodities are selected as the selected commodity. If it is determined that there is an unselected commodity, No is taken and the CPU 1 repeats the processing following ACT 1. The CPU 1 selects another unselected purchased commodity as the selected commodity and repeats the processing described above.

Incidentally, in a case in which the selected commodity is not the specific commodity, NO is taken in ACT 2 and the CPU 1 executes the processing in ACT 14.

In ACT 14, the CPU 1 confirms whether or not all the purchased commodities are selected as the selected commodity. If it is determined that there is an unselected commodity, NO is taken and the CPU 1 repeats the processing following ACT 1. On the other hand, if it is determined that all the purchased commodities are selected as the selected commodity, YES is taken and the CPU 1 executes the processing in ACT 15.

In ACT 15, the CPU 1 confirms whether or not there is no specific commodity in the purchased commodities. For example, the confirmation can be realized by setting, at any timing from the moment the CPU 1 proceeds to ACT 3 from ACT 2 to the moment the CPU 1 returns to ACT 1, a flag in a reset state in the initial state, and confirming whether or not the flag is set. Then if it is determined that there is no specific commodity, YES is taken in ACT 15 and the CPU 1 executes the processing in ACT 16.

In ACT 16, the CPU 1 controls the display for operator 18 to start a second pop-up display. The image to be displayed on the second pop-up display is stored in, for example, the auxiliary storage unit 4 in advance. The second pop-up display notifies the operator that the general receipt is being issued.

Sequentially, the CPU 1 executes the processing in ACT 17. On the other hand, if it is determined that there is a specific commodity even one and thus NO is taken in ACT 15, the CPU 1 executes the processing in ACT 17 without executing the processing in ACT 16.

In a case in which the processing in ACT 13 is executed after all the processing for each of the purchased commodities as the selected commodity described above are completed, the CPU 1 reasonably determines that YES is taken in ACT 13. In this case, the CPU 1 proceeds to ACT 17.

In ACT 17, the CPU 1 controls the printer 20 to issue a general receipt.

In ACT 18, the CPU 1 terminates the first or the second pop-up display that is being displayed. Then the CPU 1 terminates the current receipt issuing processing.

As a result of the receipt issuing processing described above, in the POS terminal 101, if the value of the determination method parameter 43 is set to 2, the number of issue sheets of the receipt ticket of each of the plurality of categories relating to one specific commodity can be varied according to the value in the number of sheets setting data 42.

Hereinafter, a specific application example of the issue of the receipt ticket in the POS terminal 101 is described.

It is assumed in the following description that the receipt ticket of No. 1 is a warranty certificate, the receipt ticket of No. 2 is an exchange ticket, and the receipt ticket of No. 3 is an exchange ticket (copy for store). In a case in which the purchase quantity of one commodity is more than one, it is necessary to issue a warranty certificate for each of the commodities, one for one. While one exchange ticket and one exchange ticket (copy for store) are issued regardless of the purchase quantity of one commodity.

In this case, the first-third codes in the number of sheets setting data 42 are set to 1, 0 and 0, respectively.

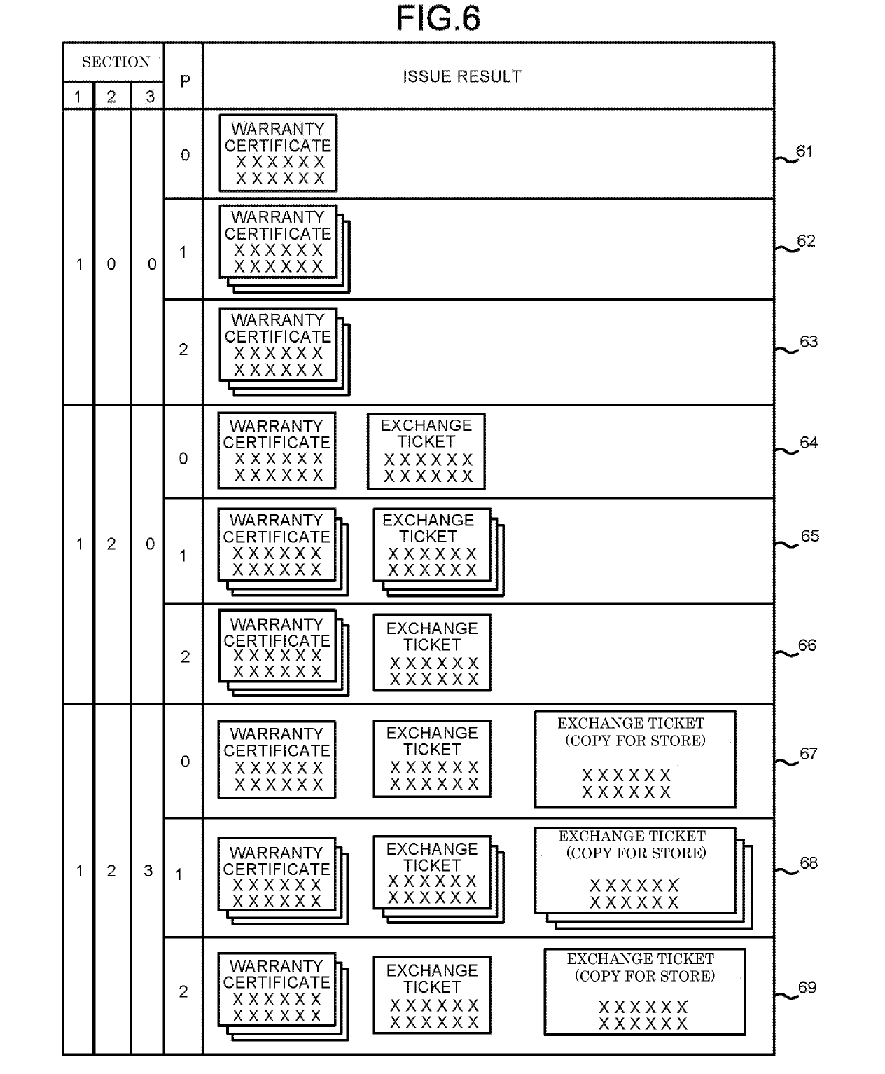

FIG. 6 is a diagram illustrating examples of the results of issuing the receipt tickets.

In FIG. 6, the results of issuing the receipt tickets for one purchased commodity of which the purchase quantity is three are exemplified.

Issue results 61, 62 and 63 indicate an issue result for a commodity for which the first-third sections are set to 1, 0 and 0, respectively. In these issue results 61, 62 and 63, only the value of the first section is set to 1, and thus, only the warranty certificate is issued as the receipt ticket of No. 1. In the issue result 63, the value P of the determination method parameter 43 is 2 and the first code is set to 1, and thus, three (the number of sheets equal to the purchase quantity) warranty certificates are issued.

Issue results 64, 65 and 66 indicate an issue result for a commodity for which the first-third sections are set to 1, 2 and 0, respectively. In these issue results 64, 65 and 66, the value of the first section is set to 1, and thus, the warranty certificate is issued as the receipt ticket of No. 1; and the value of the second section is set to 2, and thus, the exchange ticket is issued as the receipt ticket of No. 2. In the issue result 66, the value P of the determination method parameter 43 is 2 and the first and the second codes are set to 1 and 0, and thus, three (the number of sheets equal to the purchase quantity) warranty certificates are issued and one exchange ticket, is issued regardless of the purchase quantity of one commodity.

Issue results 67, 68 and 69 indicate an issue result for a commodity for which the first-third sections are set to 1, 2 and 3, respectively. In these issue results 67, 68 and 69, the value of the first section is set to 1, and thus, the warranty certificate is issued as the receipt ticket of No. 1; the value of the second section is set to 2, and thus, the exchange ticket is issued as the receipt ticket of No. 2; and the value of the third section is set to 3, and thus, the exchange ticket (copy for store) is issued as the receipt ticket of No. 3. In the issue result 69, the value P of the determination method parameter 43 is 2 and the first-third codes are set to 1, 0 and 0, and thus, three (the number of sheets equal to the purchase quantity) warranty certificates are issued and one exchange ticket and one exchange ticket (copy for store) are issued regardless of the purchase quantity.

In this way, by setting the value of the determination method parameter 43 to 2, the number of issue sheets of a receipt ticket can be varied according to the category of the receipt ticket, and an appropriate number of sheets can be issued for each category of receipt ticket.

In accordance with the present embodiment, if the value of the determination method parameter 43 is set to 0, as shown in the issue results 61, 64 and 67, it is possible to issue, one for one, a receipt ticket for each category thereof. Further, if the value of the determination method parameter 43 is set to 1, as shown in the issue results 62, 65 and 68, it is possible to issue a number of receipt tickets (equal to the purchase quantity of one commodity) for each category thereof. In this way, in accordance with the POS terminal 101 of the present embodiment, flexible operations as described above can be carried out to satisfy the needs of the user.

In the present embodiment, even in a case in which a plurality of the same commodities are purchased, the number of receipt tickets to be issued for the same commodities is changed according to the setting. In other words, the time required to issue the receipt tickets changes. However, according to the POS terminal 101 of the present embodiment, the pop-up display is carried out on the display for operator 18 during the period the receipt ticket and the general receipt are being issued, and thus, the operator can recognize whether the issue of the receipt ticket and the general receipt is continued or terminated.

Moreover, in the POS terminal 101, the content of the pop-up display is changed according to a case of issuing the receipt ticket and the general receipt and a case of issuing the general receipt only, and thus, the operator can recognize that the issue of the receipt ticket is carried out.

In this way, the notification operation with the pop-up display is carried out on the display for operator 18 under the control of the CPU 1, and therefore, the display for operator 18 functions as a notification device and the CPU 1 functions as a notification control module.

The embodiment can be implemented in various modifications as following.

Part of the single item master file 41, the number of sheets setting data 42 and the determination method parameter 43 may be stored in other storage device. Alternatively, all the single item master file 41, the number of sheets setting data 42 and the determination method parameter 43 may be stored in different storage devices, respectively. These storage devices may not be arranged inside the POS terminal 101. For example, the single item master file 41 may be stored in a storage device arranged inside or outside the server 102.

The voucher may be issued using not only a receipt paper such as the receipt ticket in the present embodiment but also a specific paper for issuing a voucher. In a case in which the specific paper is used, a printing device other than the printer 20 for issuing a receipt is also arranged to issue the voucher.

The pop-up display carried out during the issuing process of the receipt ticket may be made different from that carried out during the issuing process of the general receipt.

The order of printing the general receipt and the receipt ticket may be changed according to the circumstance in the shop. For example, it is applicable to issue the general receipt first and then issue the receipt ticket.

The number of categories of the receipt ticket may be determined by the shop. For example, it is applicable to issue only one category of receipt ticket for one commodity.

The present invention can also be applied to a sales registration apparatus, such as an electronic cash register and the like, other than the POS terminal as an embodiment similar to that described above.

The notification operation may be carried out through various visual displays different from the pop-up display or through an output such as a speech guidance.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A sales registration apparatus comprising:
a storage unit which previously stores a number of sheets setting data indicating whether the number of issue sheets of a voucher is set without regard to a purchase quantity of a commodity or to be equal to the purchase quantity of the commodity for each voucher of a plurality of categories;
an issuing module configured to issue vouchers of the plurality of categories;
a determination module configured to determine, in response to the sales registration of the commodity for which the voucher of at least one category within the plurality of categories thereof is issued, the number of issue sheets of the voucher based on the number of sheets setting data stored in the storage unit and the purchase quantity of the commodity; and
an issuing control module configured to control the issuing module to issue the voucher by the number of issue sheets determined by the determination module upon the purchase of the commodity.

2. The sales registration apparatus according to claim 1, wherein the storage unit includes an external storage device connected with the sales registration apparatus.

3. The sales registration apparatus according to claim 1, wherein
the determination module respectively determines, upon the sales registration of the commodity for which vouchers of at least two categories within the plurality of categories thereof are issued, the number of issue sheets of the vouchers of at least two categories, and
the issuing control module controls the issuing module to issue the vouchers of the at least two categories by each of the number of issue sheets respectively determined by the determination module.

4. The sales registration apparatus according to claim 1, wherein
the determination module determines, based on a parameter representing one of a first mode in which a specified number of sheets is set as the number of issue sheets of each voucher without regard to the purchase quantity of the commodity in relation to all the vouchers of the plurality of categories, a second mode in which the number of sheets equal to the purchase quantity of the commodity is set as the number of issue sheets of each voucher in relation to all the vouchers of the plurality of categories, and a third mode in which the number of sheets is set according to the number of sheets setting data, that the number of issue sheets of each voucher is set according to the number of sheets issuing data and the purchase quantity of the commodity only in a case in which the parameter represents the third mode, the number of issue sheets of each voucher is set to the specified number of sheets as the number of issue sheets without regard the purchase quantity of the commodity in a case in which the parameter represents the first mode, or the number of issue sheets of each voucher equal to the purchase quantity of the commodity is set as the number of issue sheets in a case in which the parameter represents the second mode with regard to each commodity for which vouchers of at least two categories within the plurality of categories thereof are issued.

5. The sales registration apparatus according to claim 3, wherein
the determination module determines, based on a parameter representing one of a first mode in which a specified number of sheets is set as the number of issue sheets of each voucher without regard to the purchase quantity of the commodity in relation to all the vouchers of the plurality of categories, a second mode in which the number of sheets equal to the purchase quantity of the commodity is set as the number of issue sheets of each voucher in relation to all the vouchers of the plurality of the plurality of categories, and a third mode in which the number of sheets is set according to the number of sheets setting data, that the number of issue sheets of each voucher is set according to the number of sheets issuing data and the purchase quantity of the commodity only in a case in which the parameter represents the third mode, the number of issue sheets of each voucher is set to the specified number of sheets as the number of issue sheets without regard the purchase quantity of the commodity in a case in which the parameter represents the first mode, or the number of issue sheets of each voucher equal to the purchase quantity of the commodity is set as the number of issue sheets in a case in which the parameter represents the second mode with regard to each commodity for which vouchers of at least two categories within the plurality of categories thereof are issued.

6. The sales registration apparatus according to claim 4, further comprising a change module configured to change the content of the number of sheets setting data stored in the storage device in response to the operation by an operator.

7. The sales registration apparatus according to claim 1, further comprising:
a notification device configured to notify an operator that the voucher is being issued; and
a notification control module configured to control the notification device to execute a notification operation during the operation of issuing the voucher by the issuing module.

8. A method for issuing a voucher, including:
previously storing a number of sheets setting data indicating whether the number of issue sheets of a voucher is set regardless to a purchase quantity of a commodity or to be equal to the purchase quantity of the commodity for each voucher of a plurality of categories;
determining, in response to the sales registration of the commodity for which the voucher of at least one category within the plurality of categories thereof is issued, the number of issue sheets of the voucher based on the number of sheets setting data and the purchase quantity of the commodity; and
issuing the voucher by the determined number of issue sheets, upon the purchase of the commodity.
